(19) United States
(12) Patent Application Publication
(10) Pub. No.: US 2006/0174732 A1
(43) Pub. Date: Aug. 10, 2006

(54) Adjustable wrench with two movable jaws

(75) Inventor: Joe Chen, Taichung Hsien (TW)

Correspondence Address: AKIN GUMP STRAUSS HAUER & FELD L.L.P., ONE COMMERCE SQUARE, 2005 MARKET STREET, SUITE 2200, PHILADELPHIA, PA, 19103, US

(73) Assignee: Joe Chen

(21) Appl. No.: 11/099,717

(22) Filed: Apr. 6, 2005

(30) Foreign Application Priority Data
Feb. 4, 2005 (TW) 94103698

(51) Int. Cl. B25B 13/16

(52) U.S. Cl. 81/163

(57) ABSTRACT

An adjustable wrench includes two walls disposed on an upper portion of a handle body to define a transversely extending guiding slot therebetween. A driving shaft is rotatably mounted in the guiding slot. Two movable jaws have coupling portions which are coupled respectively to two connecting ends of the driving shaft by force transmitting mechanisms such that a rotational force of the driving shaft about a rotating axis is transmitted to drive the coupling portions to move along the rotating axis toward or away from each other, and two jaw portions which extend outwardly of the guiding slot for gripping a torqued object. By operating a middle portion of the driving shaft, the distance between the jaw portions can be adjusted to permit quick gripping and releasing of the torqued object.

### BACKGROUND OF THE INVENTION

1. Field of the Invention

This invention relates to an adjustable wrench, more particularly to an adjustable wrench with two movable jaws which can be moved toward or away from each other by rotating a driving shaft.

2. Description of the Related Art

An adjustable wrench is capable of conforming to the various sizes of torqued objects, such as screw nuts. Referring to FIG. 1, a conventional adjustable wrench 10 is shown to include a handle 11, a fixed jaw 12 integrally formed with an upper end of the handle 11, a movable jaw 17 which has a rack 16 received slidably in a guiding slot 13 in the handle 11, and a worm 15 which is rotatable so as to move the rack 16 along the guiding slot 13 to be close to or away from the fixed jaw 12.

However, the conventional adjustable wrench 10 suffers from the following drawbacks:

1. Since only the movable jaw 17 is moved during rotation of the worm 15 for adjusting a distance between the jaws 12, 17, the adjusting operation is inefficient.

2. The conventional adjustable wrench 10 lacks means for retaining the rack 16 on the handle 11 when used to turn a torqued object, and is therefore susceptible to undesired movement. Besides, the torque that is produced when a force is applied to a torqued object in a turning operation is relatively small.

### SUMMARY OF THE INVENTION

An object of the present invention is to provide an adjustable wrench which can quickly grip or release a torqued object.

Another object of the present invention is to provide an adjustable wrench which has a retaining member for preventing rotation of an adjusting unit during a turning operation of a torque object.

According to this invention, the adjustable wrench includes a handle body extending in a longitudinal direction and terminating at an upper portion. Amounting seat is mounted on the upper portion, and includes two walls which are spaced apart from each other in a first transverse direction relative to the longitudinal direction to define a guiding slot therebetween. The guiding slot extends in a second transverse direction relative to the first transverse direction. Two movable jaws are disposed opposite to each other in the second transverse direction. Each of the movable jaws includes a coupling portion which is movably mounted in the guiding slot, and a jaw portion which extends from the coupling portion in the longitudinal direction and which extends outwardly of the guiding slot. A driving shaft is mounted in the guiding slot, is rotatable relative to the walls about a rotating axis in the second transverse direction, and has two connecting ends opposite to each other in the second transverse direction, and a middle portion interposed between the connecting ends. Each of two force transmitting mechanisms is disposed between a respective one of the coupling portions of the movable jaws and a respective one of the connecting ends of the driving shaft such that a rotational force of the driving shaft about the rotating axis is transmitted to drive the coupling portions to move in the second transverse direction toward or away from each other.

### BRIEF DESCRIPTION OF THE DRAWINGS

Other features and advantages of the present invention will become apparent in the following detailed description of the preferred embodiment of the invention, with reference to the accompanying drawings, in which:

FIG. 1 is a fragmentary exploded perspective view of a conventional adjustable wrench;

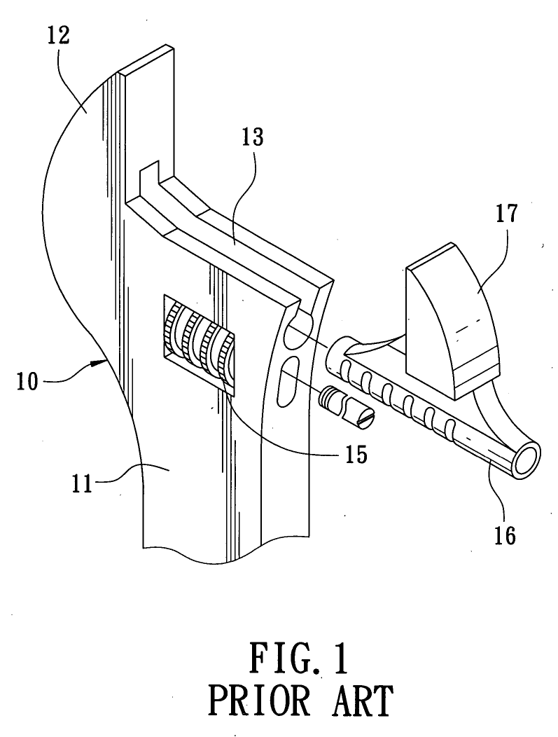

FIG. 2 is a fragmentary schematic front view of the preferred embodiment of an adjustable wrench according to this invention;

FIG. 3 is a fragmentary perspective view showing an upper portion of a handle body of the preferred embodiment;

FIG. 4 is a fragmentary exploded perspective view of the upper portion of the handle body of the preferred embodiment;

FIG. 5 is a fragmentary sectional view of the upper portion of the handle body of the preferred embodiment when a retaining member is in a retaining position;

FIG. 6 is a fragmentary sectional view of the upper portion when the retaining member is in a releasing position; and

FIG. 7 is a fragmentary schematic front view similar to FIG. 2, but showing two movable jaws close to each other.

### DETAILED DESCRIPTION OF THE PREFERRED EMBODIMENT

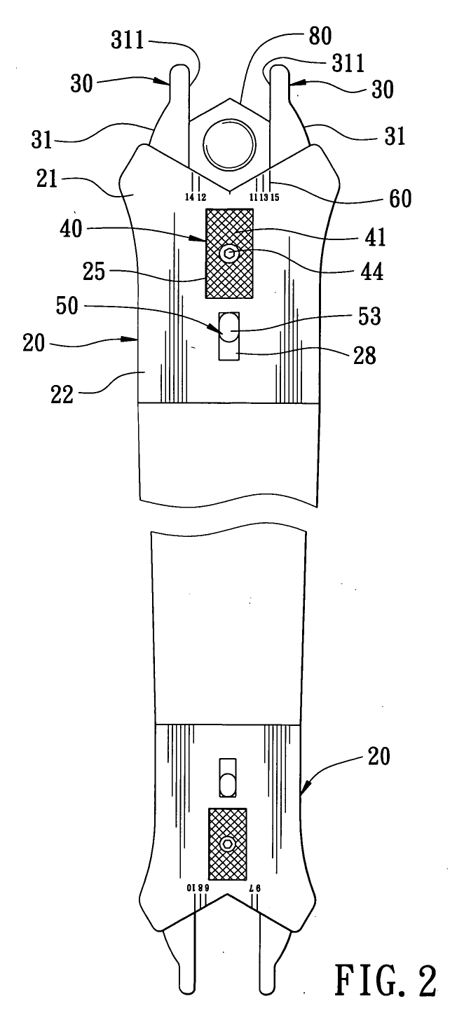

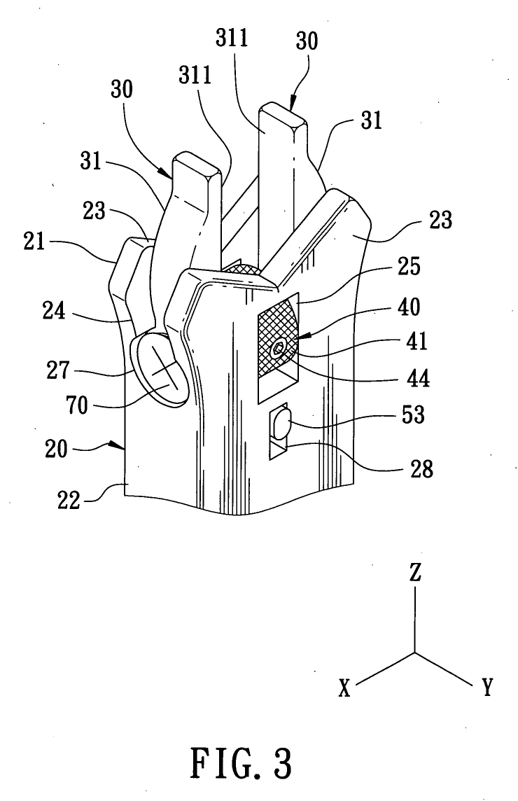

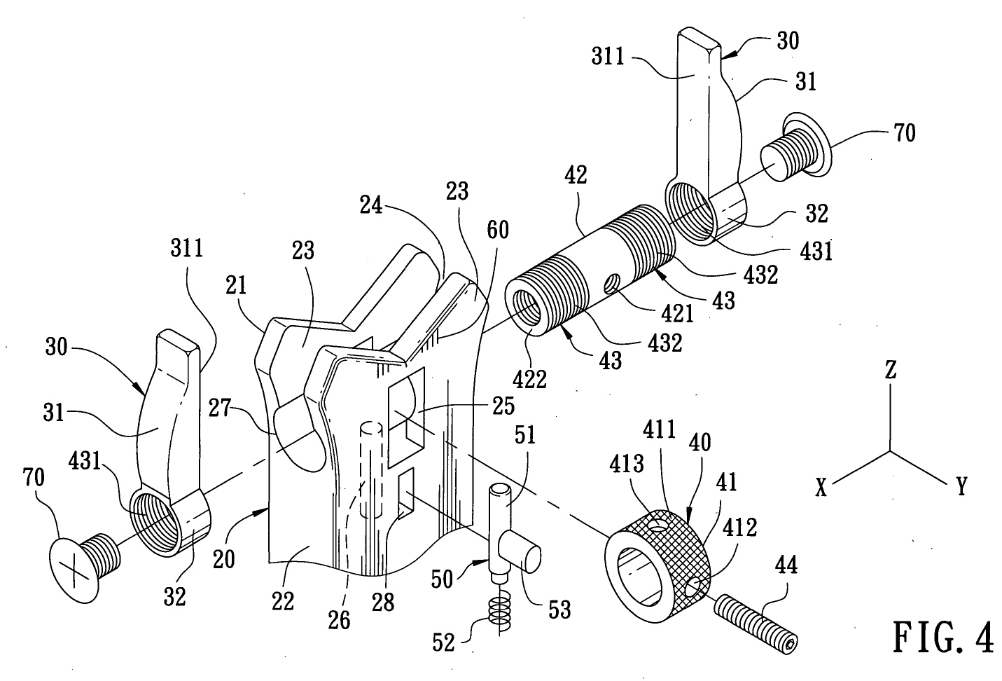

Referring to FIGS. 2 to 4, the preferred embodiment of an adjustable wrench according to the present invention is shown to comprise a handle body 20, two movable jaws 30, an adjusting unit 40, two guarding members 70, a retaining unit 50, and a scale 60.

The handle body 20 extends in a longitudinal direction (Z), and terminates at an upper portion 22. A mounting seat 21 is mounted on the upper portion 22, and includes two walls 23 which are spaced apart from each other in a first transverse direction (Y) relative to the longitudinal direction (Z) to define a guiding slot 24 therebetween. The guiding slot 24 extends in a second transverse direction (X) relative to the longitudinal direction (Z) and the first transverse direction (Y), and has an arcuate lower slot portion 27. Furthermore, one of the walls 23 has an access opening 25 and a through hole 28 which extend therethrough in the first transverse direction (Y), and which are respectively communicated with the lower slot portion 27 and an accommodation slot 26 that is formed in the upper portion 22 and that extends in the longitudinal direction (Z).

The movable jaws 30 are disposed opposite to each other in the second transverse direction (X). Each of the jaws 30 includes a coupling portion 32 which is movably mounted in the lower slot portion 27, and a jaw portion 31 which extends from the coupling portion 32 in the longitudinal direction (Z) and which extends outwardly of the guiding slot 24.

The adjusting unit 40 includes a driving shaft 42, two force transmitting mechanisms 43, and an operating ring 41. The driving shaft 42 is mounted in the lower slot portion 27, is rotatable relative to the walls 23 about a rotating axis in the second transverse direction (X), and has two connecting ends opposite to each other in the second transverse direction (X), and a middle portion interposed between the connecting ends. Each of the force transmitting mechanisms 43 includes internally and externally threaded portions 431, 432 in the form of a screw hole and a screw shank which are respectively disposed on the coupling portion 32 of the respective jaw 30 and the respective connecting end of the driving shaft 42 and which engage threadedly each other such that a rotational force of the driving shaft 42 about the rotating axis is transmitted to drive the coupling portions 32 of the jaws 30 to move in the second transverse direction toward or away from each other. Thus, the distance between gripping surfaces 311 of the jaw portions 31 of the jaws 30 can be adjusted. The scale 60 is disposed on the wall 23 to indicate the distance between the gripping surfaces 311.

The operating ring 41 is securely sleeved on the middle portion of the driving shaft 42, and is manually operable through the access opening 25 to rotate the driving shaft 42. Specifically, the operating ring 41 and the middle portion of the driving shaft 42 respectively have a through hole 412 and a fastening hole 421 extending in a direction radial to the rotating axis and registered with each other such that a fastener 44 in the form of a screw fastener passes through the through hole 412 and is securely engaged with the fastening hole 421, which is in the form of a screw hole, so as to secure the operating ring 41 on the middle portion of the driving shaft 42. The fastener 44 may also be an insert pin, whereas the fastening hole 421 may be in the form of a radial hole that receives the insert pin. The operating ring 41 has a friction surface 411 for facilitating rotational operation thereof. Furthermore, the operating ring 41 has two retaining holes 413 which are diametrically opposite to each other about the rotating axis.

The guarding members 70, which are in the form of screw bolts, are threaded into two end edges 422 of the driving shaft 42 to flank the connecting ends, respectively, so as to restrict the extent of screw-out movement of the internally threaded portion 431 relative to the externally threaded portion 432, respectively, thereby preventing slippage of the jaws 30 from the connecting ends.

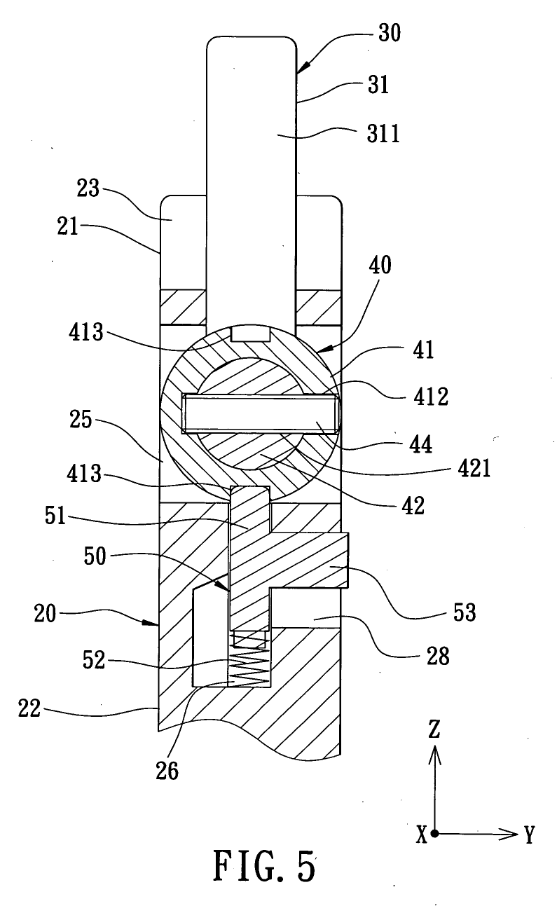

The retaining unit 50 includes a retaining member 51 and a biasing member 52. The retaining member 51 is disposed to be movable into the accommodation slot 26 in the longitudinal direction (Z), and has a retaining shank and a stem 53 which extends from the retaining shank in the first transverse direction (Y) and outwardly of the upper portion 22 of the handle body 20 through the through hole 28 for a user to externally actuate the retaining shank to move in the longitudinal direction (Z). Specifically, The retaining shank has a retaining end which is biased by the biasing member 52, such as a compression spring, to engage a selected one of the retaining holes 413 in the operating ring 41 to place the retaining member 51 in a retaining position, as shown in FIG. 5, thereby preventing rotation of the driving shaft 42 about the rotating axis.

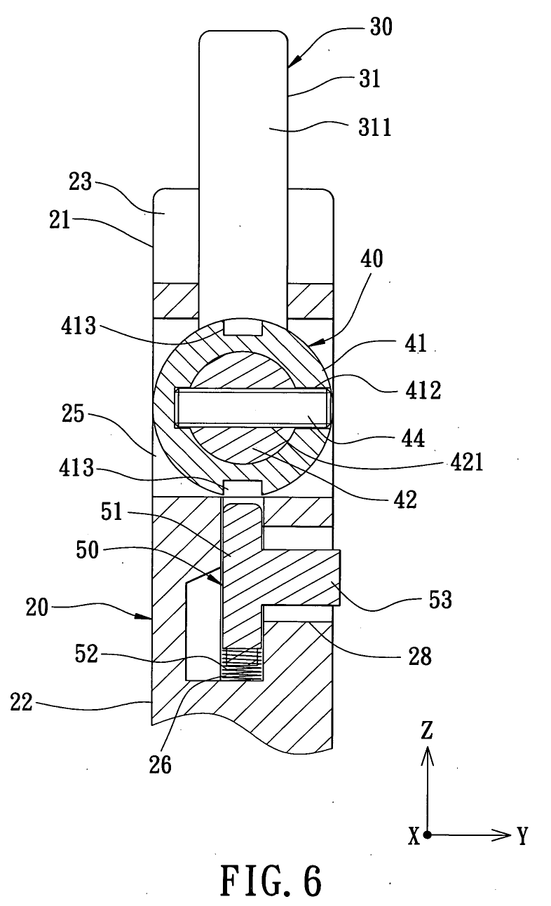

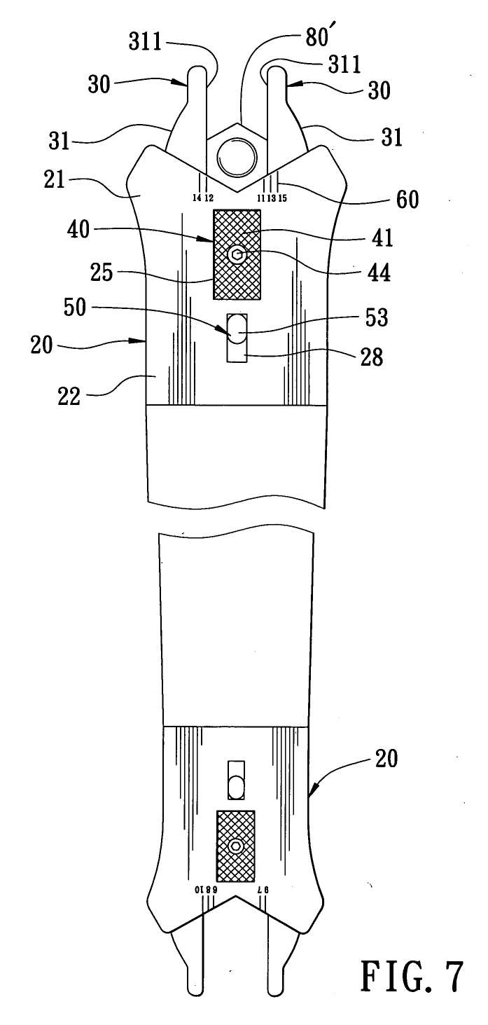

Thus, in adjusting the distance between the gripping surfaces 311 of the jaws 30, as shown in FIG. 6, the stem 53 is pushed against the biasing action of the biasing member 52 so as to move the retaining member 51 in the longitudinal direction (Z) to a releasing position, where the retaining end disengages from the retaining hole 413 to permit rotation of the driving shaft 42. The operating ring 41 is then rotated to move the jaws 30 toward each other so as to permit the gripping surfaces 311 to grip a small torqued object 80′, as shown in FIG. 7, or away from each other so as to permit the gripping surfaces 311 to grip a large torqued object 80, as shown in FIG. 2.

It is noted that the externally threaded portions 432 of the force transmitting mechanisms 43 may be configured such that when the driving shaft 42 and the operating ring 41 are rotated about 180 degrees, the jaws 30 can move relatively a distance of 1 inch, thereby permitting precise adjustment of the jaws 30 for conforming to the size of the torqued object 80, 80′.

As illustrated, according to this invention, since rotation of the operating ring 41 and the driving shaft 42 can move the jaws 30 synchronously in the second transverse direction (X), the jaws 30 can be operated to quickly grip or release a torqued object. Thus, the adjusting operation is efficient. Moreover, by virtue of the retaining member 51 which is biased by the biasing member 52 to engage a selected one of the retaining holes 413 to prevent rotation of the driving shaft 42, inadvertent movement of the jaws 30 during use of the adjustable wrench can be avoided. Besides, the torque that is produced when a force is applied to a torqued object in a turning operation can be increased.

While the present invention has been described in connection with what is considered the most practical and preferred embodiment, it is understood that this invention is not limited to the disclosed embodiment but is intended to cover various arrangements included within the spirit and scope of the broadest interpretations and equivalent arrangements.

1. An adjustable wrench comprising:
a handle body extending in a longitudinal direction and terminating at an upper portion;
a mounting seat mounted on said upper portion, and including two walls which are spaced apart from each other in a first transverse direction relative to the longitudinal direction to define a guiding slot therebetween, said guiding slot extending in a second transverse direction relative to the first transverse direction;
two movable jaws disposed opposite to each other in the second transverse direction, each of said movable jaws including a coupling portion which is movably mounted in said guiding slot, and a jaw portion which extends from said coupling portion in the longitudinal direction and which extends outwardly of said guiding slot;
a driving shaft which is mounted in said guiding slot and which is rotatable relative to said walls about a rotating axis in the second transverse direction, and which has two connecting ends opposite to each other in the second transverse direction, and a middle portion interposed between said connecting ends; and
two force transmitting mechanisms, each of which includes internally and externally threaded portions which are respectively disposed on said coupling portion of a respective one of said movable jaws and a respective one of said connecting ends of said driving shaft and which engage threadedly each other such that a rotational force of said driving shaft about the rotating axis is transmitted to drive said coupling portions to move in the second transverse direction toward or away from each other.

2. (canceled)

3. The adjustable wrench of claim 1, further comprising two guarding members which are secured to, and which are disposed to flank, said connecting ends of said driving shaft, respectively, so as to restrict extent of screw-out movement of said internally threaded portions relative to said externally threaded portions, respectively, thereby preventing slippage of said movable jaws from said connecting ends.

4. The adjustable wrench of claim 1, wherein said adjusting unit further includes an operating ring which is securely sleeved on said middle portion of said driving shaft, one of said walls having an access opening which extends therethrough in the first transverse direction and which is communicated with said guiding slot so as to permit manual operation of said operating ring to rotate said driving shaft.

5. The adjustable wrench of claim 4, further comprising a retaining member which is disposed to be movable relative to said handle body in a direction radial to the rotating axis between a retaining position where said retaining member engages said driving shaft to prevent rotation of said driving shaft, and a releasing position where said retaining member disengages from said driving shaft to permit rotation of said driving shaft; and
a biasing member disposed to bias said retaining member to the retaining position.

6. The adjustable wrench of claim 5, wherein said operating ring has a plurality of retaining holes which are angularly displaced from each other about the rotating axis, said retaining member having a retaining end which is biased to engage a selected one of said retaining holes in the retaining position.

7. The adjustable wrench of claim 5, wherein said retaining member has a retaining shank which is mounted in and which is movable relative to said handle body in the longitudinal direction, and a stem which extends from said retaining shank in the first transverse direction and which is movable with said retaining shank in the longitudinal direction, said stem being disposed to extend outwardly of said handle body for a user to externally actuate said retaining shank to move in the longitudinal direction.

8. The adjustable wrench of claim 4, wherein said operating ring and said middle portion of said driving shaft respectively have a through hole and a fastening hole, which extend in a direction radial to the rotating axis and which are registered with each other, said adjusting unit further includes a fastener which passes through said through hole and which is securely engaged with said fastening hole so as to secure said operating ring on said middle portion.

9. The adjustable wrench of claim 1, further comprising a scale which is disposed on one of said walls to indicate a distance between said movable jaws.

10. The adjustable wrench of claim 1, wherein the second transverse direction is transverse to the longitudinal direction.
